(19) United States
(12) Patent Application Publication
(10) Pub. No.: US 2010/0238582 A1
(43) Pub. Date: Sep. 23, 2010

(54) DISK APPARATUS WITH CONTACT-TYPE HEAD

(75) Inventors: Yoshitaka SUZUKI, Fussa-shi (JP); Takahiro IMAMURA, Ome-shi (JP); Yoshiaki IKAI, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/777,549

(22) Filed: May 11, 2010

Related U.S. Application Data
(63) Continuation of application No. PCT/JP2007/071940, filed on Nov. 12, 2007.

(51) Int. Cl. G11B 5/02

(52) U.S. Cl. 360/59; G9B/5.026

(57) ABSTRACT

According to one embodiment, a disk drive comprises a head and a heating actuator. The head is configured to slide over a rotating disk in contact with a surface of the disk. The heating actuator is configured to vary a state of contact between the head and the disk by being expanded by supplied heat. The head comprises the heating actuator.

### CROSS REFERENCE TO RELATED APPLICATIONS

This is a Continuation Application of PCT Application No. PCT/JP2007/071940, filed Nov. 12, 2007, which was published under PCT Article 21(2) in Japanese.

### FIELD

Embodiments described herein relate generally to a disk apparatus in which a rotating disk-shaped storage medium (that is, a disk) is accessed by a head configured to slide in contact with the disk (that is, a contact-type head).

### BACKGROUND

In recent years, alongside the development of computer technologies is the rapid development of equipment built into computers and peripheral equipment externally connected to computers. One of such technologies relates to a disk apparatus with a disk such as a magnetic disk (the disk apparatus is hereinafter referred to as a disk drive). A disk drive has a function of writing (or recording) data (or information) to a disk and a function of reading (or reproducing) data from the disk. Furthermore, many such disk drives comprise a head slider with a head used to write and read data to and from the disk. The head slider is located near the surface of the rotating disk. Thus, the head approaches the surface of the disk. In this state, the head writes and reads data to and from tracks (storage areas) on the disk.

With the rapid development of computer technologies, there has been a growing demand for a disk drive comprising a disk with an increased recording density. Thus, the recording densities of commercially available disks have been increasing year by year. In general, as the recording density of the disk increases, the approach distance between the head and the surface of the disk needs to be reduced in order to allow data to be accurately written and read. Moreover, the approach distance needs to be maintained constant.

Thus, much effort has recently been made to develop disk drives adopting what is called a contact slider method in which writing and reading of data (that is, data writing and reading) are carried out by sliding a head in contact with a rotating disk. The disk drive adopting the contact slider method has an excellent capability of holding the head close to the surface of the disk at a constant approach distance from the surface, and is thus suitable for disks with high recording densities (see, for example, Jpn. Pat. Appln. KOKAI Publication No. 2001-297421).

In the disk drive adopting the contact slider method, the head contacts the disk. Thus, to enable the write/read capability to be fulfilled, the friction between the head slider and the disk needs to be sufficiently suppressed. Furthermore, even if the friction is sufficiently low in a state immediately after manufacture of the disk drive, the level of the friction between the head slider and the disk may be increased due to the usage environment of the disk drive or temporal changes in the disk drive.

### BRIEF DESCRIPTION OF THE DRAWINGS

FIGS. 1 and 2 are diagrams showing an exemplary configuration of a hard disk drive according to an embodiment, wherein FIG. 1 is a diagram of the hard disk drive as viewed from above the hard disk drive, and FIG. 2 is a diagram of the hard disk drive as viewed from the side of the hard disk drive;

FIG. 3 is a diagram illustrating an exemplary data recording or reproducing operation in which the tip portion of a head slider is in contact with a magnetic disk;

FIGS. 4A, 4B, and 4C are diagrams illustrating the exemplary shape of the tip portion of the head slider, which varies in conjunction with thermal expansion of a heating actuator;

FIG. 5 is a diagram illustrating the exemplary relationship between the amount of thermal expansion of the heating actuator and the vibration speed of the head slider, which relationship is observed while the head slider is in contact with the magnetic disk;

FIG. 6 is a diagram illustrating an exemplary configuration of a control system for the heating actuator;

FIG. 7 is a diagram illustrating the exemplary shape of the tip portion of a head slider adopted in a hard disk drive according to a first modification of the embodiment;

FIG. 8 is a diagram illustrating the exemplary shape of the tip portion of a head slider adopted in a hard disk drive according to a second modification of the embodiment; and

FIG. 9 is an exemplary sectional view of the head slider in FIG. 8, showing a plane taken along a direction in which a heating actuator is thermally expanded.

### DETAILED DESCRIPTION

In general, according to one embodiment, a disk drive comprises a head and a heating actuator. The head is configured to slide over a rotating disk in contact with a surface of the disk. The heating actuator is configured to vary a state of contact between the head and the disk by being expanded by supplied heat. The head comprises the heating actuator.

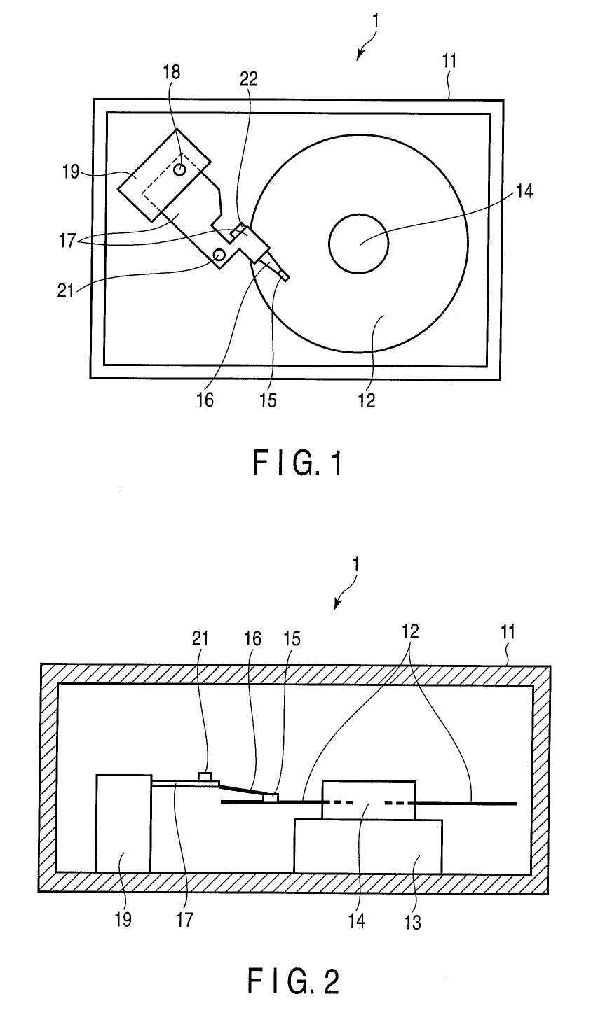

FIG. 1 is a diagram of a hard disk drive serving as a magnetic disk drive according to an embodiment as viewed from above the hard disk drive. FIG. 2 is a diagram of the hard disk drive as viewed from the side of the hard disk drive. The hard disk drive (HDD) 1 shown in FIG. 1 and FIG. 2 comprises a magnetic disk 12 provided in a housing 11. A through-hole is formed in a central portion of the disk 12. HDD 1 writes data to the magnetic disk 12 and reads the data written to the magnetic disk 12.

As shown in FIG. 2, a part of the magnetic disk 12 corresponding to the periphery of the through-hole is held sandwiched in the middle of the fixture member 14 in the vertical direction. The magnetic disk 12 is thus integrated with the fixture member 14. The fixture member 14 is rotated around the center of the magnetic disk 12 in the plane of FIG. 1 under the driving force of a driving motor 13 shown in FIG. 2; the center of the magnetic disk 12 serves as the center of rotation. The magnetic disk 12 rotates in response to the rotation of the fixture member 14.

HDD 1 comprises a head slider 15 located in the housing 11 above the magnetic disk 12 as shown in FIG. 2. The head slider 15 is supported by a carriage arm 17 via a suspension 16. The carriage arm 17 is pivotally moved around an arm shaft 18 shown in FIG. 1, under the driving force of a driving source 19 comprising a magnetizing circuit.

The carriage arm 17 appears to be folded as viewed from above HDD 1 as shown in FIG. 1. However, the carriage arm 17 appears to extend in the horizontal direction as viewed from the side of HDD 1 as shown in FIG. 2. The folded carriage arm 17 comprises a strain sensor 21 provided on the top surface of the carriage arm 17 to detect the amount of strain in the carriage arm 17. Furthermore, the carriage arm 17 comprises an acoustic emission (AE) sensor 22 configured to detect the vibration (vibration speed) of the carriage arm 17 as shown in FIG. 1. In FIG. 2, the AE sensor 22 is not shown because a side surface of the carriage arm 17 overlaps the AE sensor 22.

In HDD 1, when data is written to or read from the magnetic disk 12, the driving source 19 drives the carriage arm 17. Thus, the head slider 15 is moved to a desired track (storage area) on the rotating magnetic disk 12. The head slider 15 comprises a write element mounted in the tip portion of the slider 15 and used to write data to the magnetic disk 12, and a read element also mounted in the tip portion of the slider 15 and used to read the data written to the magnetic disk 12. Both during data writing by the write element and during data reading by the read element, the tip portion of the head slider 15 is in contact with the desired track.

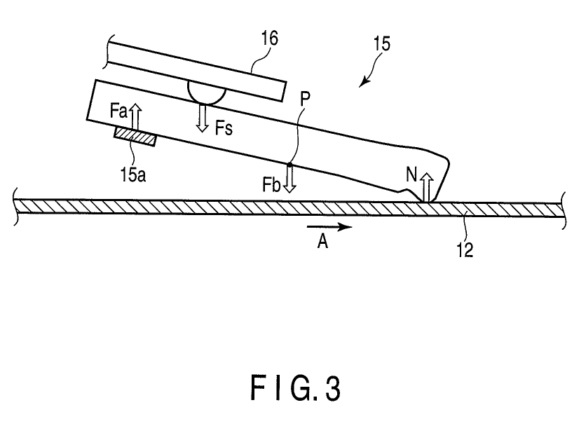

FIG. 3 is a diagram illustrating that the tip portion of the head slider is in contact with the magnetic disk in order to carry out data writing or data reading. The head slider 15 is fixed to the suspension 16 extending obliquely leftward and upward. During data writing or data reading, as shown in FIG. 3, the tip portion of the head slider 15, shown in the right of FIG. 3, comes into contact with the magnetic disk 12 rotating in the direction of arrow A in FIG. 3. A heating actuator is provided in the tip portion in juxtaposition with the above-described write and read elements. The heating actuator is supplied with heat and thus thermally expanded toward the magnetic disk 12. The thermal expansion of the heating actuator brings the head slider 15 into contact with the magnetic disk 12.

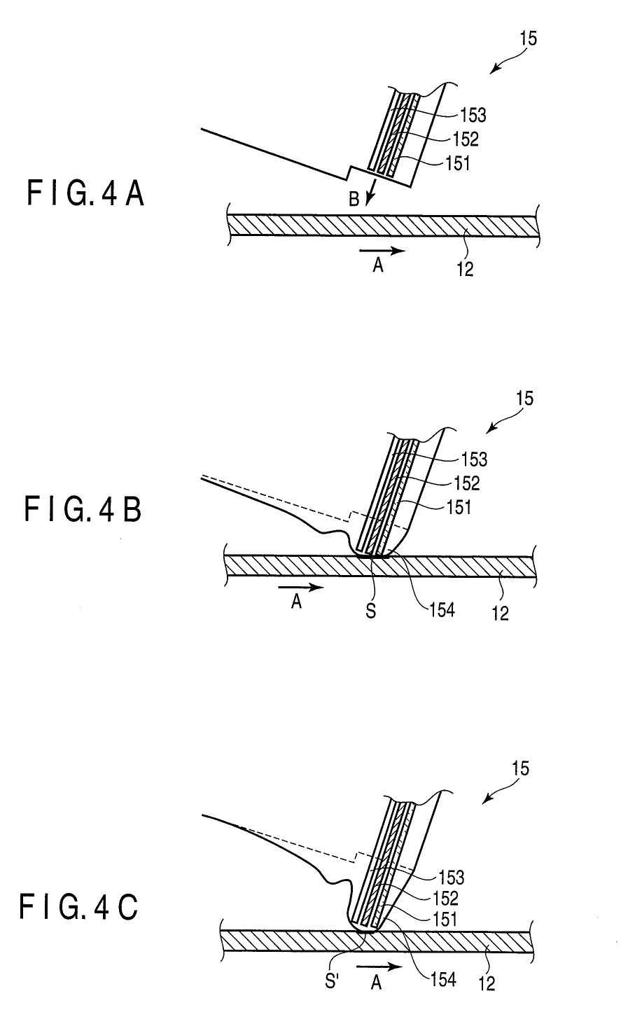

FIGS. 4A, 4B, and 4C are diagrams illustrating the shape of the tip portion of the head slide 15, which varies in conjunction with the thermal expansion of the heating actuator. In FIGS. 4A, 4B, and 4C, a heating actuator 152 is provided between a write element 151 and a read element 153. The periphery of the write element 151, the read element 153, and the heating actuator 152 is covered with a protective film 154 composed of diamond-like-carbon (DLC). The tip portion of the head slider 15 in FIG. 3, which comprises the heating actuator 152, the write element 151 and the read element 153, corresponds to a head according to the present embodiment. The heating actuator 152 is thermally expanded by a length corresponding to the amount of heat supplied.

FIG. 4A shows the state in which no heat is supplied to the heating actuator 152, which is thus not thermally expanded. In the state shown in FIG. 4A, when the heating actuator 152 is supplied with heat, the heating actuator 152 is thermally expanded in the direction of arrow B in FIG. 4A while pressing the protective film 154. In conjunction with the thermal expansion, the write element 151 and the read element 153 also move in the direction of arrow B.

In the state shown in FIG. 4A, when at least a predetermined amount of heat is supplied to the heating actuator, then as shown in FIG. 4B, a part of the tip of the head slider 15 which projects downward in FIG. 4B comes into contact with the magnetic disk 12. In the state shown in FIG. 4B, when an additional amount of heat is supplied to the heating actuator 152, the projecting part is changed into a shape projecting downward more sharply as shown in FIG. 4C. Thus, the size (contact area) S′ of the area in which the head slider 15 contacts the magnetic disk 12 in the state shown in FIG. 4C is smaller than that S of the area in which the head slider 15 contacts the magnetic disk 12 in the state shown in FIG. 4B.

Here, both during data writing to the magnetic disk 12 and during data reading from magnetic disk 12, the tip portion of the head slider 15 is in contact with the magnetic disk 12 as shown in FIG. 4B or FIG. 4C. As the magnetic disk 12 rotates in the direction of arrow A, the write element 151 and the read element 153 sequentially approach appropriate 1-bit areas arranged in each appropriate track in the magnetic disk 12. During data writing, an electric write signal (recording signal) is input to the write element 151. The write element 151 applies magnetic fields to the 1-bit areas in accordance with the input write signal to write (record) data held in the write signal, in the form of a magnetization direction in each 1-bit area. Furthermore, during data reading, the read element 153 extracts the data written in the form of the magnetization direction in each 1-bit area, as an electric read signal (reproduction signal), in accordance with magnetic fields from the 1-bit area. Here, a part of the tip portion of the head slider 15 which comprises the heating actuator and which includes a part contacting the magnetic disk 12 during data writing or read is referred to as a contact section (or a head slider contact section).

As described above, HDD 1 shown in FIG. 1 and FIG. 2 carries out data writing and reading with the head slider 15 in contact with the magnetic disk 12. Thus, the friction between the head slider 15 and the magnetic disk 12 needs to be sufficiently suppressed. The frictional force acting between the head slider 15 and the magnetic disk 12 is determined by the product of the coefficient of the friction (the coefficient of dynamic friction) between the head slider 15 and the magnetic disk 12 and a normal force exerted on the head slider 15 by the magnetic disk 12 at the contact surface between the head slider 15 and the magnetic disk 12.

The coefficient of friction increases in accordance with an increase in the contact area. On the other hand, in the head slider 15 shown in FIG. 3, the normal force does not substantially vary even with a variation in contact area as shown in FIG. 4B and FIG. 4C. Thus, in the head slider 15 shown in FIG. 3, the contact area is adjusted by controlling the amount of thermal expansion of the heating actuator 152 (the length by which the heating actuator 152 is thermally expanded). The frictional force acting between the head slider 15 and the magnetic disk 12 during data writing and reading is maintained at a predetermined level or lower.

As described above, in the embodiment, the heating actuator 152 is thermally expanded to increase the amount by which the head slider contact section projects. This enables a reduction in the contact area between the contact section of the head slider 15 and the magnetic disk 12. The reduced contact area enables a reduction in the frictional force between the head slider 15 and the magnetic disk 12. Thus, a stable write/read capability can be fulfilled.

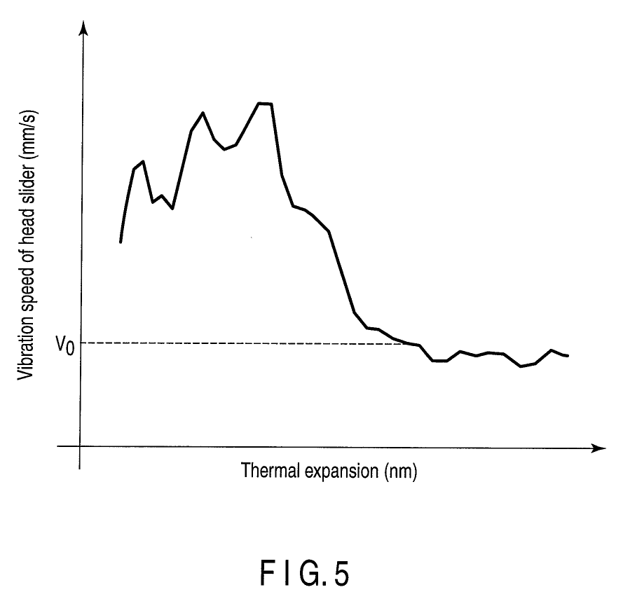

FIG. 5 is a diagram showing the relationship between the amount of thermal expansion of the heating actuator and the vibration speed of the head slider, which relationship is observed while the head slider is in contact with the magnetic disk. FIG. 5 shows a graph showing how the vibration speed (the unit is mm/s) of the head slider 15 varies as the amount of thermal expansion (the unit is nm) of the heating actuator 152 increases with the head slider 15 in contact with the magnetic disk 12. In FIG. 5, the ordinate axis indicates the root-mean-square (RMS) value of the vibration speed of the head slider 15. The RMS value of the vibration speed of the head slider 15 is acquired as follows. First, with the amount of thermal expansion of the heating actuator 152 maintained constant, the vibration speed of the head slider 15 is measured a predetermined number of times by the AE sensor 22. The RMS value of the vibration speed of the head slider 15 is obtained by determining the arithmetic average of the square values of the vibration speed of the head slider 15 detected by the predetermined number of measurements and then calculating the root-mean-square of the arithmetic average.

While the tip portion of the head slider 15 is in contact with the magnetic disk 12, the RMS value of the vibration speed of the head slider 15 increases in accordance with an increase in the frictional force acting between the head slider 15 and the magnetic disk 12. In FIG. 5, the graph as a whole shows that in spite of a slight fluctuation in areas with small amounts of thermal expansion, the RMS value of the vibration speed decreases with increasing amount of thermal expansion of the heating actuator 152.

In general, the frictional force acting between the head slider and the magnetic disk may be increased due to a usage environment of the HDD or temporal changes in the HDD. Thus, the graph in FIG. 5 shows a certain degree of variation due to environmental or temporal factors. However, the environment and temporal changes are unrelated to the qualitative tendency of the RMS value of the vibration speed of the head slider 15 to decrease in accordance with an increase in the amount of thermal expansion of the heating actuator 152 as shown in FIG. 5.

When the vibration speed of the head slider 15 exceeds a predetermined RMS value V₀ shown in FIG. 5 during data writing or reading, HDD 1 according to the present embodiment controllably increases the amount of thermal expansion of the heating actuator 152 so as to set the vibration speed to V₀ or lower. While the head slider 15 is vibrating at a vibration speed of V₀ or lower, the frictional force is weak enough to avoid affecting data writing and reading (that is, accesses to the magnetic disk 12) performed by the head slider 15. In this state, HDD 1 fulfills a stable write/read capability regardless of the environment and temporal changes.

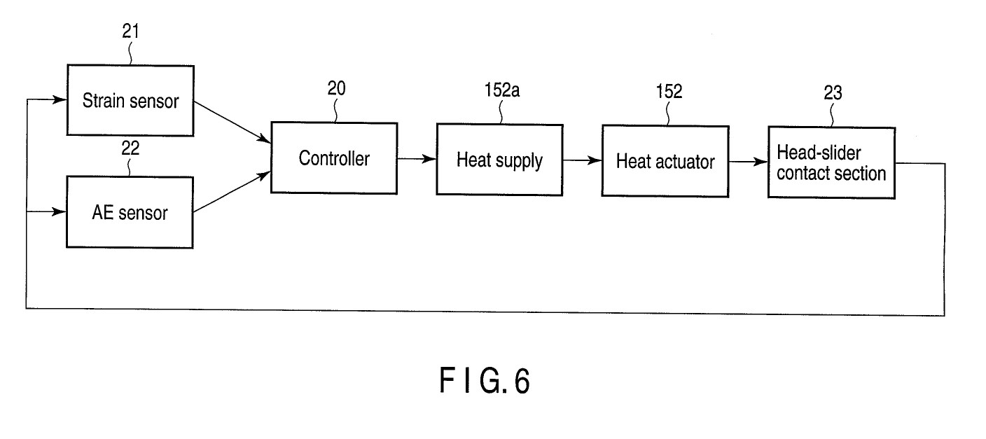

FIG. 6 is a block diagram showing the configuration of a control system for the heating actuator. HDD 1 shown in FIG. 1 and FIG. 2 comprises a control system for the heating actuator 152 configured as shown in FIG. 6. The control system comprises a heat supply 152a. The heat supply 152a comprises a heating wire configured to be heated by a current flowing through the heat supply 152a. Heat generated by the heating wire enables a variation in the frictional force acting on the contact section (head slider contact section) 23 of the head slider 15 and in the vibration speed of the contact section 23. The heat supply 152a is an electronic circuit configured to supply heat to the heating actuator 152 by allowing a current to flow through the heating wire. The heat supply 152a is controlled by a controller 20.

The control system for the heating actuator 152 further comprises a strain sensor 21 shown in FIG. 1 and FIG. 2 and an AE sensor 22 shown in FIG. 1. The amount of strain in the carriage arm 17 and the vibration speed of the head slider 15 are constantly input to the controller 20; the amount of strain in the carriage arm 17 is detected by the strain sensor 21, and the vibration speed of the head slider 15 is detected by the AE sensor 22.

The controller 20 determines whether or not the amount of strain in the carriage arm 17 detected by the strain sensor 21 exceeds a predetermined value. The predetermined strain amount is used as a threshold value required to determine whether or not the head slider 15 is in contact with the magnetic disk 12. The controller 20 further determines whether or not the vibration speed of the head slider 15 detected by the AE sensor 22 is at least the above-described predetermined RMS value (threshold value) v₀ (see FIG. 5). When the amount of strain in the carriage arm 17 is equal to or smaller than the predetermined value, the head slider 15 is not in contact with the magnetic disk 12. On the other hand, as described with reference to FIG. 5, when the vibration speed of the head slider 15 exceeds the threshold value v₀, the friction between the head slider 15 and the magnetic disk 12 is too high to carry out data writing or reading. Thus, the controller 20 controls the heat supply 152a until the amount of strain in the carriage arm 17 exceeds the predetermined value and until the vibration speed of the head slider 15 becomes equal to or lower than the threshold value v₀. The controller 20 thus allows the heat supply 152a to supply heat to the heating actuator 152.

Now, the normal force exerted on the head slider 15 by the magnetic disk 12 at the contact surface between the head slider 15 and the magnetic disk 12 will be described. FIG. 3 shows the normal force N exerted on the head slider 15 by the magnetic disk 12 at the contact surface, as well as the direction of the normal force N. Besides the normal force N, plural forces are applied to the head slider 15 in the vertical direction in FIG. 3. The normal force N is balanced with the plural types of forces to maintain the state shown in FIG. 3. The normal force N can be determined by an expression for the balance of the forces as described below.

As shown in FIG. 3, the head slider 15 comprises a positive pressure generator 15a on a part of a surface of the slider 15 which is located opposite the magnetic disk 12. The positive pressure generator 15a generates a floating force Fa acting to float the head slider 15 away from the magnetic disk 12, owing to an air flow resulting from rotation of the magnetic disk 12. The floating force Fa acts in a direction in which the head slider 15 is separated from the magnetic disk 12; the floating force Fa acts upward in FIG. 3. That is, the head slider 15 allows the positive pressure generator 15a to generate an upward force of the magnitude Fa. This force decreases with increasing distance from the surface of the magnetic disk 12 to the positive pressure generator 15a, and thus behaves similarly to the tensile force of a spring acting to return to its natural length. The positive pressure generator 15a forms a separator for the head slider 15 due to the functions of the generator 15a.

Furthermore, most of the surface of the head slider 15 located opposite the magnetic disk 12, except for the part on which the positive pressure generator 15a is provided, serves to generate a push-down aerodynamic force owing to the air flow resulting from the rotation of the magnetic disk 12. The push-down aerodynamic force acts in a direction in which the head slider 15 approaches the magnetic disk 12; in FIG. 3, the push-down aerodynamic force acts in the direction in which the head slider 15 is pushed downward. The push-down aerodynamic force can be virtually considered to be a local force acting at a position P on the surface of the head slider 15 shown in FIG. 3. The magnitude of the push-down aerodynamic force is defined as Fb. FIG. 3 shows the magnitude Fb and direction of the push-down aerodynamic force at the position P.

The floating force Fa exerted by the positive pressure generator 15a and the push-down aerodynamic force Fb acting at the position P are determined by the structure of the surface of the head slider 15 which is located opposite the magnetic disk 12. A well-known technique such as the one described in Jpn. Pat. Appln. KOKAI Publication No. 2005-276284 can be used for this structure (surface structure).

Furthermore, the head slider 15 is subjected to a downward force (pressing force) Fs exerted by the suspension 16 and acting to press the head slider 15 toward the magnetic disk 12. The vertical force acting on the head slider 15 includes the weight of the head slider 15. However, the magnitude of the weight of the head slider 15 is much smaller than that of each of the normal force N, floating force Fa, push-down aerodynamic force Fb, and pressing force Fs (exerted by the suspension 16), all of which are described above. Thus, the weight of the head slider 15 is negligible.

The state shown in FIG. 3 is maintained by balancing the four forces; the normal force N, the floating force Fa, the push-down aerodynamic force Fb, and the pressing force Fs. Thus, the following holds true.

N+Fa=Fb+Fs (1)

Based on Expression (1), the normal force N is expressed as follows using the floating force Fa, the push-down aerodynamic force Fb, and the pressing force Fs.

N=Fb+Fs−Fa (2)

Here, the pressing force Fs, that is, the pressing force Fs exerted by the suspension 16, is constant and is not affected by a variation in the contact state between the head slider 15 and the magnetic disk 12 shown in FIGS. 4A, 4B, and 4C. Furthermore, the push-down aerodynamic force Fb is not substantially affected by a variation in the contact state. Furthermore, the floating force Fa does not substantially vary even if the position of the positive pressure generator 15a is varied in the up-down direction in FIG. 3 by the thermal expansion of the heating actuator 152. This is because the rigidity of the positive pressure generator 15a, which determines the behavior of the floating force Fa, is sufficiently low. Thus, Expression (2) indicates that the normal force N is maintained almost constant even though the constant state between the head slider 15 and the magnetic disk 12 varies as shown in FIGS. 4A, 4B, and 4C. As a result, as described above, a decrease in the contact area between the head slider 15 and the magnetic disk 12 enables a reduction in the coefficient of the friction between the head slider 15 and the magnetic disk 12 and thus in frictional force. Thus, according to the embodiment, with the head slider 15 in contact with the magnetic disk 12, the frictional force between the head slider 15 and the magnetic disk 12 can be kept at a sufficiently small level. Hence, HDD according to the present embodiment can fulfill a stable data write/read capability.

[First Modification]

As described above, the embodiment controllably reduces the frictional force acting between the head slider 15 and the magnetic disk 12 with the normal force maintained constant. The embodiment thus controllably reduces the normal force and thus the frictional force. A first modification of the embodiment will be described. An HDD according to the first modification is configured similarly to HDD 1 according to the embodiment except that the first modification adopts a head slider different from the head slider 15 shown in FIG. 3. Thus, aspects of the first modification of the embodiment which are common to the embodiment will not be described. In the description below, the head slider adopted in the first modification will be focused on.

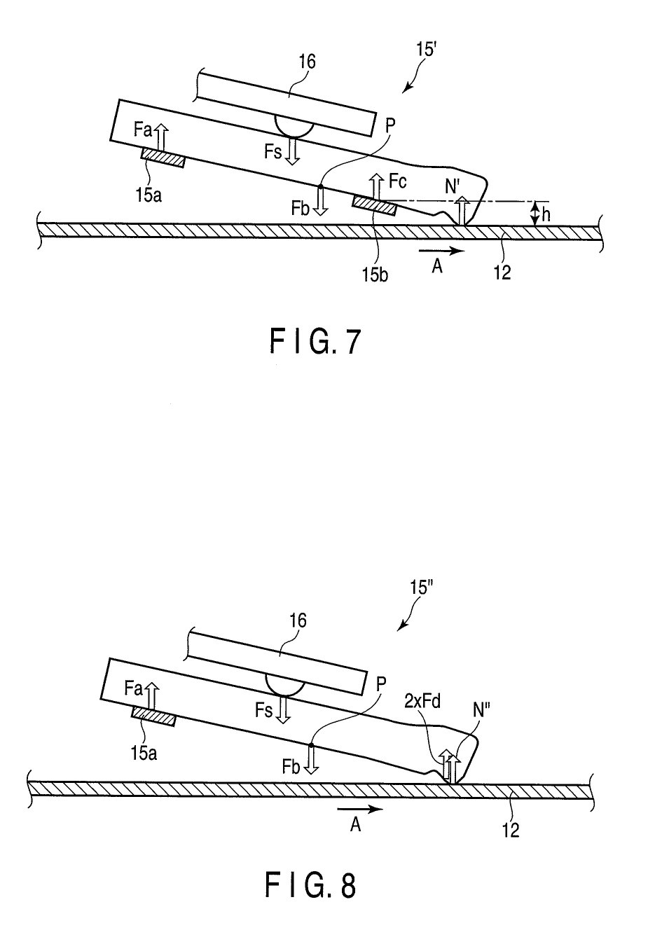

FIG. 7 is a diagram illustrating the head slider adopted in the HDD according to the first modification of the embodiment. The same components of the head slider in FIG. 7 as those of the head slider 15 in FIG. 3 are denoted by the same reference numerals as shown in FIG. 3. The head slider 15′ shown in FIG. 7 is different from the head slider 15 in FIG. 3 in the following two points. A first difference is that the head slider 15′ comprises a positive pressure generator 15b in addition to the positive pressure generator 15a shown in FIG. 3. A second difference is that the position of the connection between the suspension 16 and the head slider 15′ is shifted slightly rightward of the position of the connection between the suspension 16 and the head slider 15 in FIG. 3a such that a torque generated by the newly added positive pressure generator 15b is cancelled.

In the first modification, for differentiation of the two positive pressure generators, the positive pressure generator 15a, shown in the left of FIG. 7, is referred to as the first positive pressure generator 15a, and the positive pressure generator 15b, shown in the right of FIG. 7, is referred to as the second positive pressure generator 15b. The second positive pressure generator 15b generates a floating force Fc acting to float the head slider 15′ from the magnetic disk 12. The two positive pressure generators 15a and 15b form a separator for the head slider 15′ due to the functions of the generators 15a and 15b.

Like the floating force Fa generated by the first positive pressure generator 15a, the floating force Fc generated by the second positive pressure generator 15b decreases with increasing distance (h) from the surface of the magnetic disk 12 to the second positive pressure generator 15b. However, in the head slider 15′ shown in FIG. 7, the shape of the second positive pressure generator 15b is improved such that the second positive pressure generator 15b is rigid enough to suppress the amount of thermal expansion of the head slider contact section.

The magnitude N′ of the normal force exerted by the magnetic disk 12 on the head slider 15′ shown in FIG. 7 is expressed by the right side of Expression (2) to which the upward floating force Fc exerted by the second positive pressure generator 15b is added. That is, the normal force N′ exerted on the head slider 15′ is expressed as follows using the floating force Fc and the three forces described above with reference to FIG. 3 (specifically, the floating force Fa, the push-down aerodynamic force Fb, and the pressing force Fs).

N′=Fb+Fs−Fa−Fc (3)

Like the tip portion of the head slider 15 described with reference to FIG. 4, the tip portion of the head slider 15′, shown in the right of FIG. 7, comprises the write element 151, the read element 153, and the heating actuator 152. However, FIG. 7 shows none of the write element 151, the read element 152, and the heating actuator 152. In the head slider 15′ shown in FIG. 7, the tip portion of the head slider 15′ projects downward more sharply as the amount of thermal expansion of the heating actuator 152 increases. In this case, the second positive pressure generator 15b is configured so as to be much more rigid than the positive pressure generator of the head slider 15 shown in FIG. 3.

As the distance (h) between the second positive pressure generator 15b and the magnetic disk 12 increases in conjunction with the thermal expansion of the heating actuator 152, the floating force Fc exerted by the second positive pressure generator 15b decreases. Thus, as is apparent from Expression (3) described above, the normal force N′ increases in conjunction with the thermal expansion of the heating actuator 152. If the second positive pressure generator 15b is rigid enough to reduce the amount of thermal expansion of the head slider contact section, the contact area between the head slider 15′ and the magnetic disk 12 does not substantially vary. The coefficient of the friction between the head slider 15′ and the magnetic disk 12 also does not substantially vary. Thus, an increase in the normal force N′ increases the frictional force between the head slider 15′ and the magnetic disk 12.

Furthermore, as is the case with the head slider 15 described with reference to FIG. 4, if the contact area between the head slider 15′ and the magnetic disk 12 shown in FIG. 7 decreases in conjunction with the thermal expansion of the heating actuator 152, the coefficient of friction also decreases. However, even in this case, in the head slider 15′ shown in FIG. 7, the frictional force increases in conjunction with the thermal expansion of the heating actuator 152 provided that while the heating actuator 152 is thermally expanded, if the effect of an increase in normal force N′ is greater than that of a decrease in the coefficient of friction.

Thus, the HDD according to the first modification of the embodiment is different from HDD 1 according to the embodiment in that the HDD according to the first modification of the embodiment increases the amount of thermal expansion of the heating actuator 152 and thus the frictional force. However, the HDD according to the first modification, that is, an HDD adopting the head slider 15′ shown in FIG. 7, also uses a control system for the heating actuator 152 configured as shown in FIG. 6 to adjust the amount of thermal expansion of the heating actuator 152. That is, in the above-described first modification, the controller 20 controls the heat supply 152a to adjust the amount of thermal expansion of the heating actuator 152 so that the amount of strain in the carriage arm 17 exceeds a predetermined value and so that the vibration speed of the head slider 15 is equal to or lower than the threshold value v₀.

[Second Modification]

In the embodiment and the first modification, as shown in FIG. 4, the heating actuator 152 is thermally expanded to allow the write element 151 and the read element 153 to project toward the magnetic disk 12, thus varying the frictional force. Now, a second modification of the embodiment will be described, in which the heating actuator 152 is thermally expanded to allow the positive pressure generator to project toward the magnetic disk 12, thus varying the frictional force. The HDD according to the second modification is configured similarly to HDD 1 according to the embodiment except that the second modification adopts a head slider different from the head slider 15 shown in FIG. 3. Thus, aspects of the second modification of the embodiment which are common to the embodiment will not be described. In the description below, the head slider adopted in the second modification will be focused on.

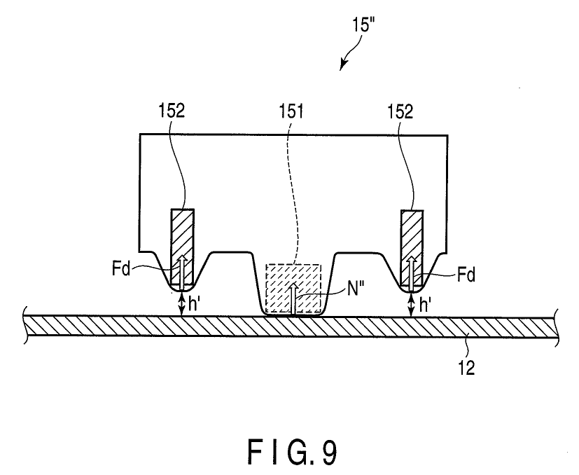

FIG. 8 is a diagram illustrating the head slider adopted in the HDD according to the second modification of the embodiment. The head slider is characterized in that the heating actuator 152 is thermally expanded to allow the positive pressure generator to project toward the magnetic disk 12, thus varying the frictional force between the head slider and the magnetic disk. FIG. 9 is a sectional view of the head slider in FIG. 8, showing a plane along the direction in which the heating actuator is thermally expanded. The same components of the head slider in FIG. 8 and FIG. 9 as those of the head slider 15 in FIG. 3 are denoted by the same reference numerals as shown in FIG. 3.

The head slider 15″ shown in FIG. 8 and FIG. 9 is different from the head slider 15 in FIG. 3 in the following two points. A first difference is that in the head slider 15″ shown in FIG. 8 and FIG. 9, the write element 151 and the read element 153 are provided in the center of the tip portion of the head slider 15″ which is in constant contact with the magnetic disk 12. FIG. 8 shows none of the write element 151, the read element 152, and the heating actuator 153. FIG. 9 does not show the read element 153. In FIG. 9, the read element 153 is provided behind the write element 151 as viewed from the reader. A second difference is that the head slider 15″ comprises one heating actuator 152 on each of the opposite sides of the set of the write element 151 and read element 153.

Here, the tip portion of the head slider 15″ comprising the two heating actuators 152, the write element 151, and the read element 153 forms a head. A central part of the tip portion of the head slider 15″ which is in constant contact with the magnetic disk 12 forms a contact section of the head slider 15″ (head slider contact section).

In the head slider 15″ shown in FIG. 8 and FIG. 9, the vicinity of the tip portion of each of the two heating actuators 152 which extends toward the magnetic disk 12 forms a positive pressure generator. Like the floating force Fa generated by the positive pressure generator 15a (see FIG. 8) located on the left side of the head slider 15″, a floating force Fd exerted by each of the two positive pressure generators decreases with increasing distance h′ from the surface of the magnetic disk 12 to each of the two positive pressure generators. However, in the head slider 15″ shown in FIG. 8 and FIG. 9, the shape of the vicinity of the tip portion of each of the two positive pressure generators extending toward the magnetic disk 12 is improved so that the positive pressure generator is much more rigid than the positive pressure generator 15a. Here, the positive pressure generator located near the tip portion of each of the two heating actuators 152 forms a separator for the head slider 15″ due to the functions of the generator.

The magnitude N″ of the normal force exerted by the magnetic disk 12 on the contact section (head slider contact section) of the head slider 15″, located at the center of the tip portion of the slider 15″, is expressed by the right side of Expression (2), to which the upward floating force Fd exerted by the positive pressure generator located near the tip portion of each of the two heating actuators 152 is added. That is, the normal force N″ exerted on the head slider 15″ is expressed as follows using the two floating forces Fd and the three forces described above with reference to FIG. 3 (specifically, the floating force Fa, the push-down aerodynamic force Fb, and the pressing force Fs).

N″=Fb+Fs−Fa−2×Fd (4)

The positive pressure generator located near the tip portion of each of the two heating actuators 152 is very rigid. Thus, as each of the two actuators is thermally expanded to reduce the distance h′ from the surface of the magnetic disk 12 to the corresponding positive pressure generator, the floating force Fd exerted by the corresponding positive pressure generator increases. Thus, as is apparent from Expression (4) described above, the normal force N″ decreases in conjunction with the thermal expansion of the heating actuator 152. On the other hand, the contact area between the head slider 15″ and the magnetic disk 12 shown in FIG. 8 and FIG. 9 does not vary even with the thermal expansion of the heating actuator 152. The coefficient of the friction between the head slider 15″ and the magnetic disk 12 also does not vary. Therefore, the frictional force decreases in conjunction with the thermal expansion of the heating actuator 152.

As described above, like HDD 1 according to the embodiment, the HDD according to the second modification of the embodiment increases the amount of thermal expansion of the heating actuator 152 to reduce the frictional force. The mechanism of a reduction in frictional force in the HDD according to the second modification is different from that in HDD 1 according to the embodiment. However, the HDD according to the second modification, that is, the HDD adopting the head slider 15″ shown in FIG. 8 and FIG. 9, also uses the control system for the heating actuator 152 configured as shown in FIG. 6 to adjust the amount of thermal expansion of the heating actuator 152. That is, in the above-described second modification, the controller 20 controls the heat supply 152a to adjust the amount of thermal expansion of the heating actuator 152 so that the amount of strain in the carriage arm 17 exceeds a predetermined value and so that the vibration speed of the head slider 15 is equal to or lower than the threshold value v₀.

In the description of the embodiment and the modifications of the embodiment (first and second modifications), the contact between the head slider and the magnetic disk is focused on. However, a lubricant may be applied onto the magnetic disk in order to reduce the frictional force generated during the contact. Furthermore, in the embodiment, the head slider is separate from the disk as shown in FIG. 4A while no heat is supplied to the heating actuator, thus preventing the heating actuator from being thermally expanded. However, the head slider may be in contact with the disk even while the heating actuator is not being thermally expanded.

Furthermore, a disk drive other than a magnetic disk drive (hard disk drive) may be used, provided that the disk drive comprises a contact-type head. The disk drive may be of a read-only type (that is, the disk drive may be dedicated to read access).

The various modules of the storage apparatus described herein can be implemented as software applications, hardware and/or software modules. While the various modules are illustrated separately, they may share some or all of the same underlying logical or code.

While certain embodiments have been described, these embodiments have been presented by way of example only, and are not intended to limit the scope of the inventions. Indeed, the novel disk drives described herein may be embodied in a variety of other forms; furthermore, various omissions, substitutions and changes in the form of the disk drives described herein may be made without departing from the spirit of the inventions. The accompanying claims and their equivalents are intended to cover such forms or modifications as would fall within the scope and spirit of the inventions.

What is claimed is:

1. A disk drive comprising:
a head configured to slide over a rotating disk in contact with a surface of the disk; and
a heating actuator configured to change a state of contact between the head and the disk due to expansion by supplied heat, the head comprising the heating actuator.

2. The disk drive of claim 1, further comprising:
a sensor configured to detect a frictional force between the head and the disk; and
a heat supply controller configured to control heat supply to the heating actuator based on the detected frictional force,
wherein the contact state is adjusted by controlling the heat supply to the heating actuator.

3. The disk drive of claim 1, further comprising a head slider comprising the head, the head slider further comprising a separator configured to generate a floating force from an air flow due to rotation of the disk, the floating force separating the head slider from the disk.

4. The disk drive of claim 3, wherein:
the head comprises a contact portion configured to access the disk; and
the contact portion comprises the heating actuator, and the heating actuator is configured to change the state of the contact with the disk by deforming the contact portion in accordance with thermal expansion of the heating actuator.

5. The disk drive of claim 4, wherein:
the contact portion is configured to project toward the disk in accordance with thermal expansion of the heating actuator;
an area of a surface where the contact portion contacts the disk decreases as a projecting amount of the contact portion increases; and
the frictional force between the head and the disk decreases as the area of the contact surface decreases.

6. The disk drive of claim 5, wherein the separator comprises a rigidity substantially equal to a magnitude in order to prevent the floating force from being changed in accordance with a change in the projecting amount of the contact portion.

7. The disk drive of claim 4, wherein:
the contact portion is configured to project toward the disk in accordance with thermal expansion of the heating actuator;
a distance between the separator and the disk increases as the projecting amount of the contact portion increases;
the floating force decreases as the distance increases; and
the frictional force between the head and the disk increases as the floating force decreases.

8. The disk drive of claim 7, wherein the rigidity of the separator is substantially equal to a magnitude in such a manner that the floating force decreases as the projecting amount of the contact portion increases.

9. The disk drive of claim 1, wherein:
the head comprises a contact portion configured to access the disk, and a separator configured to generate a floating force from an air flow due to rotation of the disk, the floating force separating the head slider from the disk;
the separator comprises the heating actuator, and the heating actuator is configured to change the floating force by deforming the separator in accordance with thermal expansion of the heating actuator; and
the frictional force between the head and the disk is configured to change depending on a variation in the floating force.

10. The disk drive of claim 9, wherein:
the contact portion is configured to project toward the disk in accordance with thermal expansion of the heating actuator;
a distance between the separator and the disk decreases as a projecting amount of the contact portion increases;
the floating force increases as the distance decreases; and
the frictional force between the head and the disk decreases as the floating force increases.
